(19) United States
(12) Patent Application Publication
(10) Pub. No.: US 2026/0140135 A1
(43) Pub. Date: May 21, 2026

(54) PHYSICAL QUANTITY SENSOR ELEMENT AND PHYSICAL QUANTITY SENSOR DEVICE

(71) Applicant: SEIKO EPSON CORPORATION, Tokyo (JP)

(72) Inventor: Masataka Kazuno, Kofu-shi (JP)

(21) Appl. No.: 19/392,692

(22) Filed: Nov. 18, 2025

(30) Foreign Application Priority Data
Nov. 20, 2024 (JP) 2024-202039

(51) Int. Cl. G01P 15/097

(52) U.S. Cl. CPC G01P 15/097

(57) ABSTRACT

A physical quantity sensor element includes a first fixed inter digital transducer coupled to a first electrode fixing portion and including a main body extending in a first direction parallel to a support substrate, and comb teeth extending in a second direction parallel to the support substrate and orthogonal to the first direction, a second fixed inter digital transducer coupled to a second electrode fixing portion and including a main body extending in the second direction, and comb teeth extending in the first direction, a first movable inter digital transducer coupled to a movable electrode fixing portion and arranged opposite to the first fixed inter digital transducer, and a second movable inter digital transducer arranged opposite to the second fixed inter digital transducer. At time of self-diagnosis, a signal having a frequency equal to a resonance frequency of the first movable inter digital transducer and the second movable inter digital transducer is applied between the first movable inter digital transducer and the first fixed inter digital transducer and between the second movable inter digital transducer and the second fixed inter digital transducer.

The present application is based on, and claims priority from JP Application Serial Number 2024-202039, filed November 20, 2024, the disclosure of which is hereby incorporated by reference herein in its entirety.

### BACKGROUND

### 1. Technical Field

The present disclosure relates to a physical quantity sensor element and a physical quantity sensor device.

### 2. Related Art

In the related art, a sensor that detects physical quantities along two axes orthogonal to each other is known. For example, JP-A-2003-121457 discloses a configuration of a capacitive physical quantity sensor in which fixed electrodes and movable electrodes are arranged opposite to each other in parallel and distances between the fixed electrodes and the movable electrodes change in accordance with physical quantities and in which two sets of the fixed electrodes and the movable electrodes corresponding to two axes are formed to detect physical quantities along the two axes. JP-A-2003-121457 discloses a configuration in which, for self-diagnosis by such a sensor, input voltages having different frequencies are applied to a first detector that detects acceleration in an X-axis direction and a second detector that detects acceleration in a Y-axis direction, and in which the self-diagnosis is simultaneously performed in the first detector and the second detector.

In the above-described related art, since the input voltages having the different frequencies are applied to the first detector that detects the acceleration in the X-axis direction and the second detector that detects the acceleration in the Y-axis direction, there is a possibility that a displacement during the self-diagnosis of any one of the first detector and the second detector may be small.

### SUMMARY

To solve the above-described problems, according to an aspect of the present disclosure, a physical quantity sensor element includes: a first electrode fixing portion, a second electrode fixing portion, and a movable electrode fixing portion that extend in a direction orthogonal to a support substrate; a first fixed inter digital transducer coupled to the first electrode fixing portion and including a main body extending in a first direction parallel to the support substrate, and comb teeth extending in a second direction parallel to the support substrate and orthogonal to the first direction; a second fixed inter digital transducer coupled to the second electrode fixing portion and including a main body extending in the second direction, and comb teeth extending in the first direction; a first movable inter digital transducer coupled to the movable electrode fixing portion and arranged opposite to the first fixed inter digital transducer; and a second movable inter digital transducer arranged opposite to the second fixed inter digital transducer. The first movable inter digital transducer and the second movable inter digital transducer have a same resonance frequency. At time of self-diagnosis, a signal for displacing the first movable inter digital transducer and the second movable inter digital transducer and having a frequency equal to the resonance frequency is applied between the first movable inter digital transducer and the first fixed inter digital transducer and between the second movable inter digital transducer and the second fixed inter digital transducer.

### BRIEF DESCRIPTION OF THE DRAWINGS

FIG. 1 is a plan view of a physical quantity sensor device according to the present embodiment.

FIG. 2 is a plan view of an XY-direction acceleration sensor element according to the present embodiment.

FIG. 3 is a diagram schematically illustrating the displacement of a movable body.

FIG. 4 is a plan view of movable inter digital transducers and fixed inter digital transducers.

FIG. 5 is a plan view of movable inter digital transducers and fixed inter digital transducers.

FIG. 6 is a plan view illustrating a structure of the movable body.

FIG. 7 is an explanatory diagram of a circuit for detecting acceleration.

FIG. 8 is a diagram illustrating signal waveforms at the time of switching from normal acceleration detection to self-diagnosis.

FIG. 9 is an enlarged view of signal waveforms at the time of acceleration detection.

FIG. 10 is a graph illustrating resonance frequency characteristics of movable transducers.

FIG. 11 is a graph illustrating the relationship between voltage and displacement.

### DESCRIPTION OF EMBODIMENTS

The present embodiment will be described below. Note that the present embodiment described below does not unduly limit the scope of the claims. In addition, not all of the configurations described in the present embodiment are necessarily essential configuration requirements.

### Configuration of Physical Quantity Sensor Device

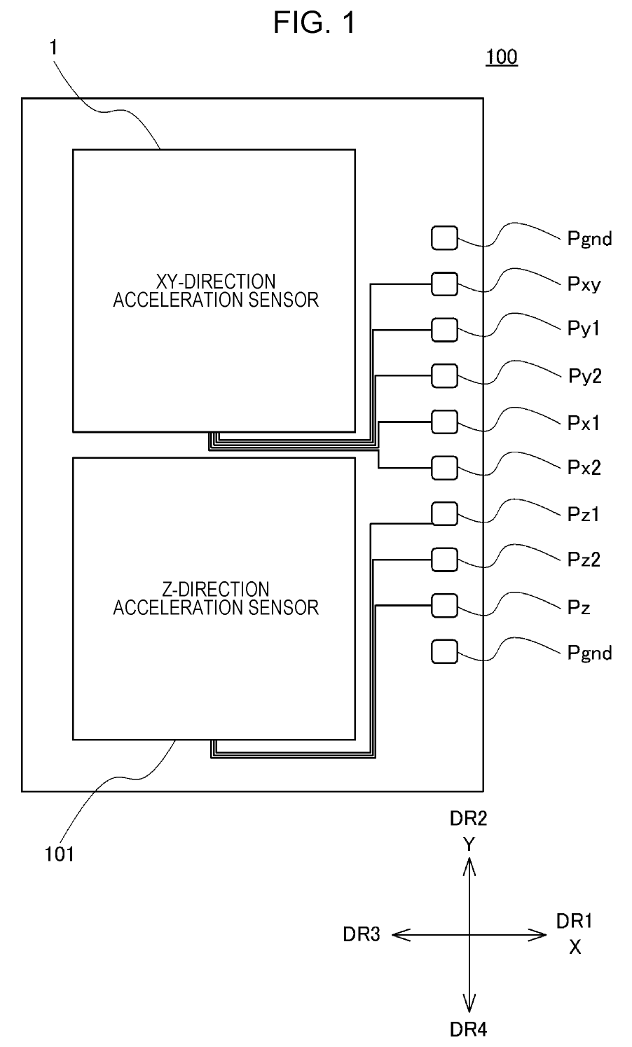

A physical quantity sensor device 100 according to the present embodiment is accommodated in a substantially rectangular parallelepiped package. FIG. 1 is a plan view illustrating a state in which the physical quantity sensor device 100 is viewed in a direction orthogonal to the largest surface of the rectangular parallelepiped. A state in which each portion is viewed in the direction is referred to as a plan view. The physical quantity sensor device 100 according to the present embodiment includes a plurality of physical quantity sensor elements. Specifically, the physical quantity sensor device 100 includes a Z-direction acceleration sensor element 101 and an XY-direction acceleration sensor element 1. Each of the sensor elements is a micro-electro-mechanical systems (MEMS) device.

In the present specification, directions orthogonal to each other are referred to as a first direction DR1 and a second direction DR2, a direction opposite to the first direction DR1 is referred to as a third direction DR3, and a direction opposite to the second direction DR2 is referred to as a fourth direction DR4. The first direction DR1 and the second direction DR2 are, for example, an X-axis direction and a Y-axis direction, respectively, but are not limited thereto. For example, the first direction DR1 corresponding to the X-axis direction and the second direction DR2 corresponding to the Y-axis direction are directions parallel to the largest surface of the rectangular parallelepiped in which the physical quantity sensor device 100 is formed. In a case where it is not particularly necessary to distinguish the opposite directions, for example, the third direction DR3 can be regarded as a direction in the first direction DR1. In addition, the case where the directions are "orthogonal" to each other includes not only a case where the directions intersect each other at 90° but also a case where the directions intersect each other at an angle slightly different from 90°.

FIG. 1 also illustrates a plurality of pads included in the physical quantity sensor device 100. A pad Pgnd is electrically coupled to a ground portion. A pad Pxy is electrically coupled to a movable inter digital transducer (described later) included in the XY direction acceleration sensor element 1, and has a common electrical potential in the X-axis direction and the Y-axis direction. A pad Py1 is electrically coupled to a fixed inter digital transducer (described later) included in the XY-direction acceleration sensor element 1, and has an electrical potential for detecting acceleration in the Y-axis direction. A pad Py2 is electrically coupled to a fixed inter digital transducer (described later) included in the XY-direction acceleration sensor element 1, and has an electrical potential opposite in phase to that of the pad Py1 in order to detect acceleration in the Y-axis direction.

A pad Px1 is electrically coupled to a fixed inter digital transducer (described later) included in the XY-direction acceleration sensor element 1, and has an electrical potential for detecting acceleration in the X-axis direction. A pad Px2 is electrically coupled to a fixed inter digital transducer (described later) included in the XY-direction acceleration sensor element 1, and has an electrical potential opposite in phase to that of the pad Px1 in order to detect accelerations in the X-axis direction.

A pad Pz is electrically coupled to a first movable inter digital transducer (not illustrated) and a second movable inter digital transducer (not illustrated) that are included in the Z-direction acceleration sensor element 101. A pad Pz1 is electrically coupled to a first fixed inter digital transducer (not illustrated) included in the Z-direction acceleration sensor element 101, and has an electrical potential for detecting acceleration in a Z-axis direction. A pad Pz2 is electrically coupled to a second fixed inter digital transducer (not illustrated) included in the Z-direction acceleration sensor element 101, and has an electrical potential opposite in phase to that of the pad Pz1 in order to detect acceleration in the Z-axis direction.

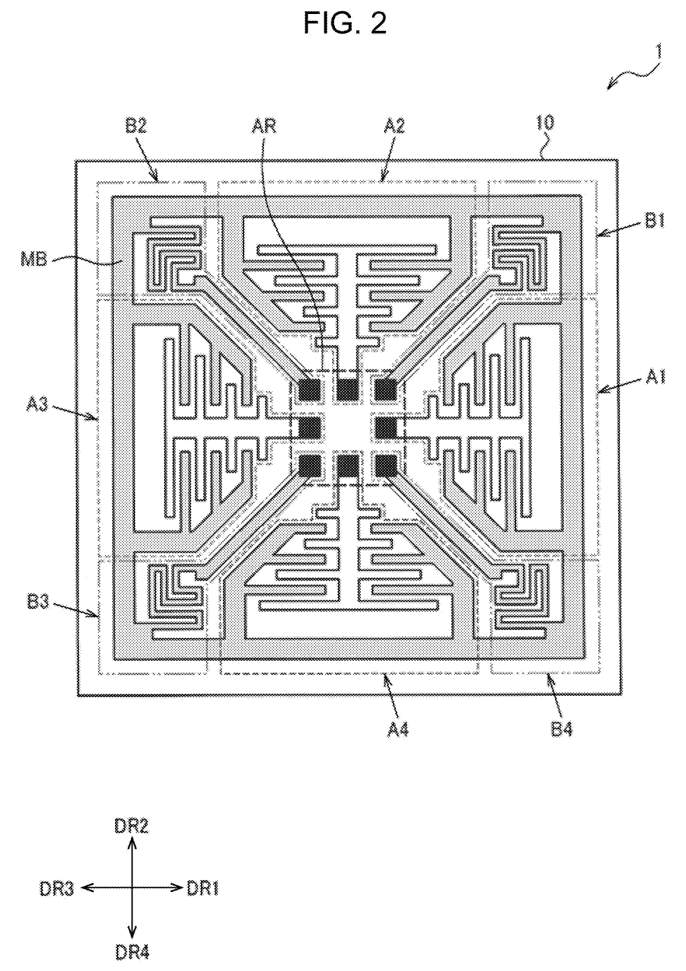

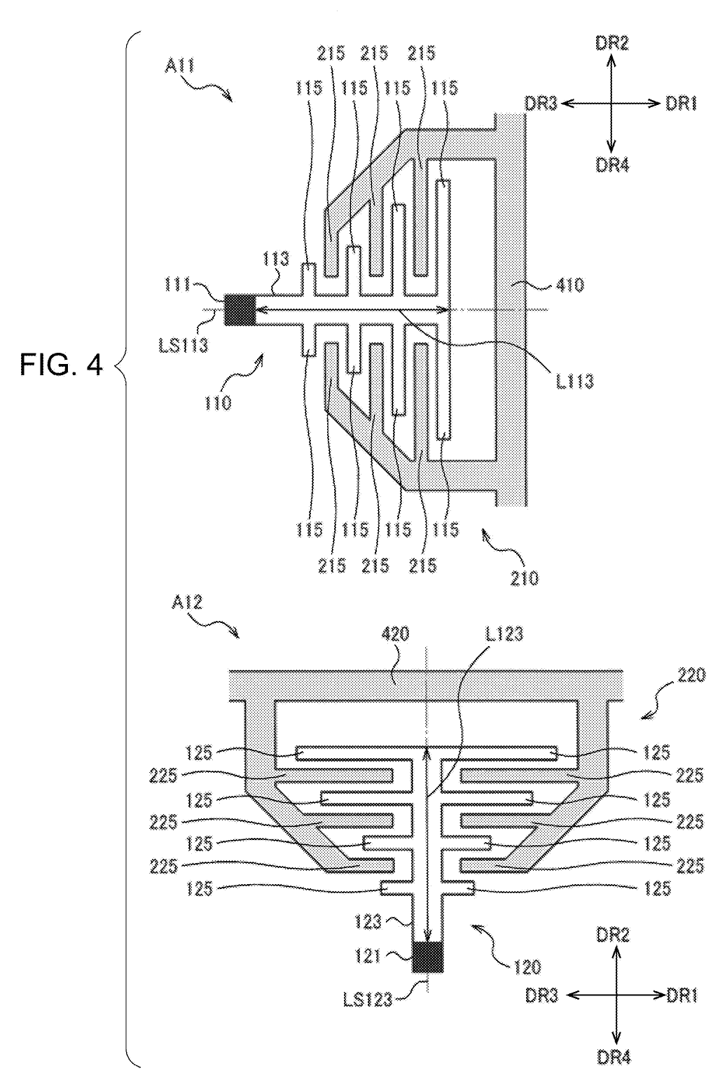

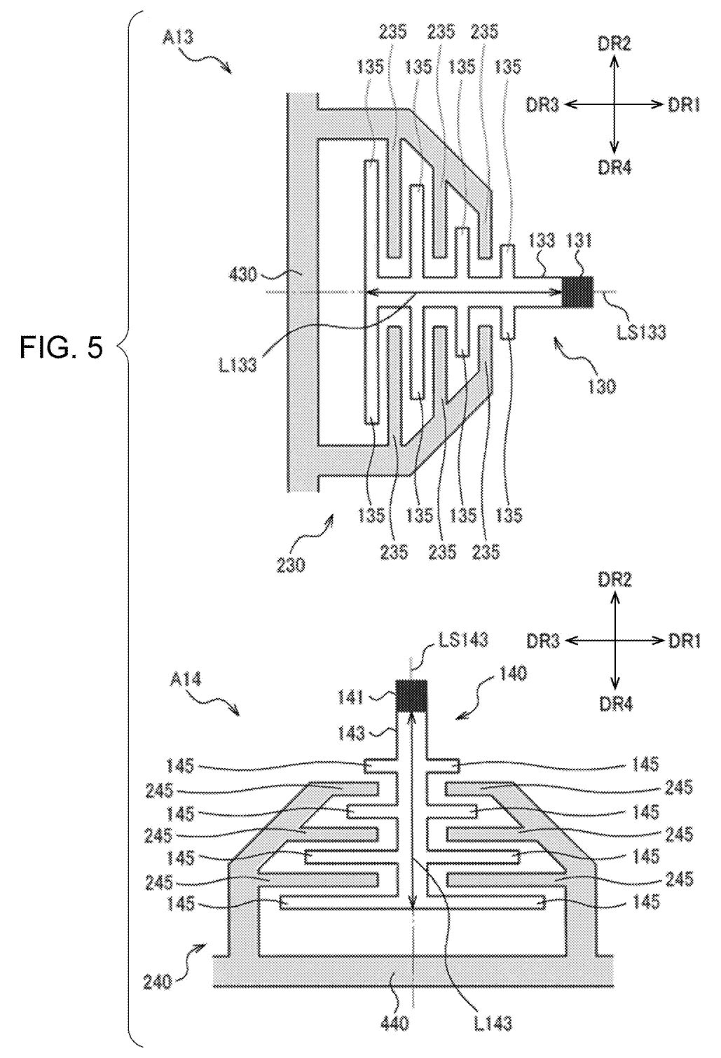

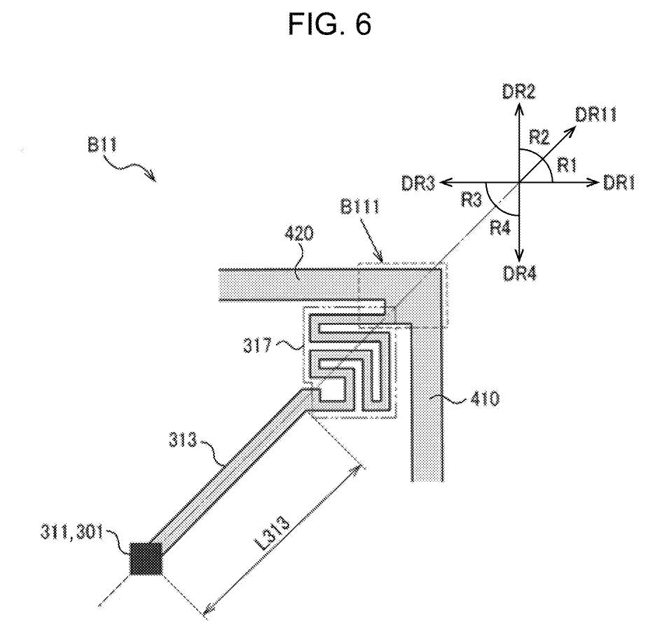

FIG. 2 schematically illustrates an example of the XY-direction acceleration sensor element 1 according to the present embodiment in plan view. In the XY-direction acceleration sensor element 1 illustrated in FIG. 2, a frame-shaped movable body MB is coupled to a support substrate 10. Although FIG. 2 illustrates the movable body MB that forms one closed loop in plan view, a portion of the movable body MB may be opened. Other configurations coupled to the support substrate 10 or the movable body MB will be described later separately with reference to FIGS. 4, 5, and FIG. 6. Specifically, a configuration illustrated in a dotted line frame A1 in FIG. 2 corresponds to a configuration denoted by A11 in FIG. 4 described later, a configuration illustrated in a dotted line frame A2 in FIG. 2 corresponds to a configuration denoted by A12 in FIG. 4 described later, and a configuration illustrated in a dotted line frame B1 in FIG. 2 corresponds to a configuration denoted by B11 in FIG. 6 described later. A configuration illustrated in a dotted line frame A3 in FIG. 2 corresponds to a configuration denoted by A13 in FIG. 5 described later, and a configuration illustrated in a dotted line frame A4 in FIG. 2 corresponds to a configuration denoted by A14 in FIG. 5 described later. A configuration illustrated in a dotted line frame B2 in FIG. 2 is a configuration obtained by horizontally inverting the configuration illustrated in the dotted line frame B1 in FIG. 2 symmetrically with respect to a line parallel to the second direction DR2. A configuration illustrated in a dotted line frame B3 in FIG. 2 is a configuration obtained by vertically inverting the configuration illustrated in the dotted line frame B2 in FIG. 2 symmetrically with respect to a line parallel to the first direction DR1. A configuration illustrated in a dotted line frame B4 in FIG. 2 is a configuration obtained by vertically inverting the configuration illustrated in the dotted line frame B1 in FIG. 2 symmetrically with respect to the line parallel to the first direction DR1.

Further, in implementing a method according to the present embodiment, not all of the configurations illustrated in FIG. 2 are essential, and some of the configurations may be omitted. Specifically, for example, the configurations illustrated in the dotted line frames A3, A4, B2, B3, and B4 in FIG. 2 may be appropriately omitted or modified.

The support substrate 10 is, for example, a silicon substrate made of semiconductor silicon or a glass substrate made of a glass material such as borosilicate glass. However, the constituent material of the support substrate 10 is not particularly limited, and a quartz substrate, a silicon on insulator (SOI) substrate, or the like may be used as the support substrate 10. Note that the support substrate 10 may have various shapes, and for example, the support substrate 10 may have a cavity formed in a direction orthogonal to the first direction DR1 and the second direction DR2. A predetermined region AR is a region in which a first electrode fixing portion, a second electrode fixing portion, a movable electrode fixing portion, and the like are concentrated and coupled to the support substrate 10, and may also be referred to as a fixing portion coupling region.

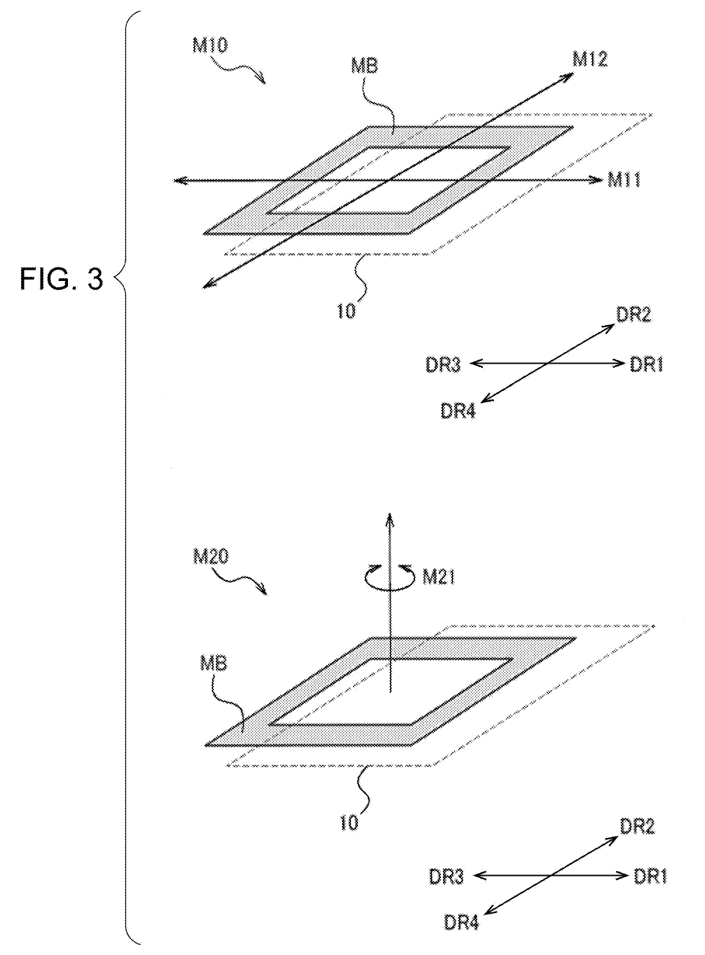

The XY-direction acceleration sensor element 1 according to the present embodiment is, for example, an inertial sensor as a micro-electro-mechanical systems (MEMS) device, and detects physical quantities in the first direction DR1 and the second direction DR2. That is, the XY-direction acceleration sensor element 1 detects a physical quantity in an operation mode illustrated by M10 in FIG. 3. M10 indicates the operation mode in which the movable body MB and each component included in the movable body MB operate in a direction indicated by M11 or in a direction indicated by M12. The direction indicated by M11 matches a direction in the first direction DR1, and the direction indicated by M12 matches a direction in the second direction DR2. Thus, physical quantities in the first direction DR1 and the second direction DR2 are detected by a method described later. Strictly speaking, the XY-direction acceleration sensor element 1 may operate in an operation mode indicated by M20 in FIG. 3, for example. The operation mode indicated by M20 corresponds to an operation in which the movable body MB rotates about an axis indicated by M21 with respect to a plane including the support substrate 10, and can also be referred to as an in-plane rotation mode. However, the XY-direction acceleration sensor element 1 according to the present embodiment is configured such that the operation based on the operation mode indicated by M20 is negligibly small compared with the operation in the operation mode indicated by M10.

A case where a physical quantity detected by the XY-direction acceleration sensor element 1 is acceleration will be mainly described below as an example, but the physical quantity is not limited to acceleration, and may be another physical quantity such as speed, pressure, displacement, posture, angular velocity, or gravity, and the XY-direction acceleration sensor element 1 may be used as a pressure sensor, a MEMS switch, or the like. In addition, all of the drawings in the present embodiment schematically illustrate the dimensions of members, distances between the members, and the like for convenience of description, and do not indicate actual dimensions, distances, and the like. Some constituent elements such as electrodes and wiring in the XY-direction acceleration sensor element 1 according to the present embodiment are appropriately omitted in the drawings.

As indicated by A11 in FIG. 4, the XY-direction acceleration sensor element 1 according to the present embodiment includes a first fixed inter digital transducer 110 and a first movable inter digital transducer 210. The first movable inter digital transducer 210 includes a first coupling portion 410. The first coupling portion 410 is configured as a portion of the movable body MB and extends in the second direction DR2.

The first fixed inter digital transducer 110 is fixed to the support substrate 10, and is coupled to a first electrode fixing portion 111 extending in a direction orthogonal to the support substrate 10. The first fixed inter digital transducer 110 includes a main body 113 coupled to the first electrode fixing portion 111 and extending in the first direction DR1, and a plurality of comb teeth 115. The comb teeth 115 of the first fixed inter digital transducer 110 are portions extending from the main body 113 in the second direction DR2 (and in the fourth direction DR4). In the present embodiment, lengths of the comb teeth 115 extending in the second direction DR2 are equal to lengths of the comb teeth 115 extending in the fourth direction DR4. Note that the case where "the lengths are equal" includes not only a case where the lengths are actually equal, but also a case where the lengths can be regarded as being equal in consideration of a manufacturing error. That is, the first fixed inter digital transducer 110 is symmetrical with respect to a line segment LS113 illustrated in FIG. 4. The line segment LS113 passes through the first electrode fixing portion 111 and extends in the first direction DR1. The first fixed inter digital transducer 110 is fixed to the support substrate 10 via the first electrode fixing portion 111 and serves as a probe electrode.

The first electrode fixing portion 111 indicated in A11 in FIG. 4 only conceptually indicates a portion where the main body 113 is fixed to the support substrate 10, and does not indicate a specific structure of the first electrode fixing portion 111. The same applies to a second electrode fixing portion 121 and the like described later.

The first movable inter digital transducer 210 has a plurality of comb teeth 215. The comb teeth 215 extend in the second direction DR2 (and in the fourth direction DR4) and face the comb teeth 115. In the present embodiment, as indicated by A11 in FIG. 4, the comb teeth 215 present in the second direction DR2 are symmetrical to the comb teeth 215 present in the fourth direction DR4 with respect to the line segment LS113. Although not strictly illustrated, a movable electrode is disposed on a side surface of the comb teeth 215, a fixed electrode is disposed on a side surface of the comb teeth 115, and the movable electrode and the fixed electrode can function as probe electrodes. The first movable inter digital transducer 210 serves as a probe electrode that is capable of moving integrally with the movable body MB.

It can be considered that a combination of the first fixed inter digital transducer 110 and the first movable inter digital transducer 210 constitutes one physical quantity detection unit. Hereinafter, a physical quantity detection unit is simply referred to as a detection unit. That is, it can be considered that FIG. 2 described above illustrates a detection unit illustrated in the dotted line frame A1, a detection unit illustrated in the dotted line frame A2, a detection unit illustrated in the dotted line frame A3, and a detection unit illustrated in the dotted line frame A4. Although the number of the comb teeth 115 and the number of the comb teeth 215 are not limited to the numbers illustrated in FIGS. 2 and 4, it is assumed that the comb teeth 115 are arranged on both sides of the comb teeth 215 in a plan view of the support substrate 10. This arrangement can stabilize the operation of the movable body MB.

An example of the operation of the detection unit that has the combination of the first fixed inter digital transducer 110 and the first movable inter digital transducer 210 and is denoted by A11 in FIG. 4 will be described. For example, when acceleration is generated in the X-axis direction that is the first direction DR1, the comb teeth 215 are displaced along the X axis, the distances between the comb teeth 215 and the comb teeth 115 in the direction along the X axis change, and thus electrostatic capacitance changes. That is, the detection unit that has the combination of the first fixed inter digital transducer 110 and the first movable inter digital transducer 210 and is denoted by A11 in FIG. 4 is capable of detecting acceleration in the X-axis direction.

On the other hand, for example, when acceleration is generated in a direction in the second direction DR2, an area where the comb teeth 115 that extend from the main body 113 in the second direction DR2 face the comb teeth 215 increases, but an area where the comb teeth 115 that extend from the main body 113 in the fourth direction DR4 face the comb teeth 215 decreases. Similarly, when acceleration is generated in a direction in the fourth direction DR4, the area where the comb teeth 115 that extend from the main body 113 in the second direction DR2 face the comb teeth 215 decreases, but the area where the comb teeth 115 that extend from the main body 113 in the fourth direction DR4 face the comb teeth 215 increases. That is, when acceleration is generated in a direction in the second direction DR2 and when acceleration is generated in a direction in the fourth direction DR4, the total area where the comb teeth 115 face the comb teeth 215 does not change. In other words, the detection unit that has the combination of the first fixed inter digital transducer 110 and the first movable inter digital transducer 210 and is denoted by A11 in FIG. 4 is configured not to detect acceleration in the Y-axis direction.

In this manner, the comb teeth 115 extend from the main body 113 in the second direction DR2 and the fourth direction DR4, and thus the detection unit that detects acceleration in the X-axis direction but does not detect acceleration in the Y-axis direction is constructed. That is, it can be said that the cross-axis sensitivity of the detection unit that has the combination of the first fixed inter digital transducer 110 and the first movable inter digital transducer 210 and is denoted by A11 in FIG. 4 is suppressed.

As indicated by A12 in FIG. 4, the XY-direction acceleration sensor element 1 according to the present embodiment includes a second fixed inter digital transducer 120 and a second movable inter digital transducer 220. The second movable inter digital transducer 220 includes a second coupling portion 420. The second coupling portion 420 is configured as a portion of the movable body MB and extends in the first direction DR1.

The second fixed inter digital transducer 120 is fixed to the support substrate 10 and is coupled to the second electrode fixing portion 121 extending in the direction orthogonal to the support substrate 10. The second fixed inter digital transducer 120 is coupled to the second electrode fixing portion 121 and includes a main body 123 extending in the second direction DR2 and a plurality of comb teeth 125. The comb teeth 125 of the second fixed inter digital transducer 120 are portions extending from the main body 123 in the first direction DR1 (and in the third direction DR3). In the present embodiment, lengths of the comb teeth 125 extending in the first direction DR1 are equal to lengths of the comb teeth 125 extending in the third direction DR3. The second fixed inter digital transducer 120 is symmetrical with respect to a line segment LS123 illustrated in FIG. 4. The line segment LS123 passes through the second electrode fixing portion 121 and extends in the second direction DR2. The second fixed inter digital transducer 120 is fixed to the support substrate 10 via the second electrode fixing portion 121 and serves as a probe electrode.

The second movable inter digital transducer 220 has a plurality of comb teeth 225. The comb teeth 225 extend in the first direction DR1 (and in the third direction DR3) and face the comb teeth 125. In the present embodiment, as indicated by A12 in FIG. 4, the comb teeth 225 present in the first direction DR1 are symmetrical to the comb teeth 225 present in the third direction DR3 with respect to the line segment LS123. The second movable inter digital transducer 220 serves as a probe electrode that is capable of moving integrally with the movable body MB.

As is clear from FIG. 4, a detection unit that has the combination of the second fixed inter digital transducer 120 and the second movable inter digital transducer 220 and is denoted by A12 in FIG. 4 can be regarded as having the same configuration as that of the detection unit that has the combination of the first fixed inter digital transducer 110 and the first movable inter digital transducer 210, is denoted by A11 in FIG. 4, and is rotated counterclockwise by 90°. Therefore, although a detailed description will be partially omitted, the detection unit that has the combination of the second fixed inter digital transducer 120 and the second movable inter digital transducer 220 and is denoted by A12 in FIG. 4 is capable of detecting acceleration in the Y-axis direction, and the cross-axis sensitivity of the detection unit is suppressed.

The configuration illustrated in the dotted line frame A3 in FIG. 2 corresponds to the configuration denoted by A13 in FIG. 5 described later. The configuration denoted by A13 in FIG. 5 is obtained by inverting the configuration denoted by A11 in FIG. 4 symmetrically with respect to a line parallel to the second direction DR2. That is, a first fixed inter digital transducer 130 is fixed to the support substrate 10 and is coupled to a first electrode fixing portion 131 extending in the direction orthogonal to the support substrate 10. The first fixed inter digital transducer 130 includes a main body 133 coupled to the first electrode fixing portion 131 and extending in the third direction DR3, and a plurality of comb teeth 135. The comb teeth 135 of the first fixed inter digital transducer 130 are portions extending from the main body 133 in the second direction DR2 (and in the fourth direction DR4). The first movable inter digital transducer 230 includes a third coupling portion 430. The third coupling portion 430 is configured as a portion of the movable body MB and extends in the second direction DR2. The first movable inter digital transducer 230 has a plurality of comb teeth 235. The comb teeth 235 extend in the second direction DR2 (and in the fourth direction DR4) and face the comb teeth 135.

The configuration illustrated in the dotted line frame A4 in FIG. 2 corresponds to the configuration denoted by A14 in FIG. 5 described later. The configuration denoted by A14 in FIG. 5 is obtained by inverting the configuration denoted by A11 in FIG. 4 symmetrically with respect to the line parallel to the first direction DR1. That is, a second fixed inter digital transducer 140 is fixed to the support substrate 10 and is coupled to a second electrode fixing portion 141 extending in the direction orthogonal to the support substrate 10. The second fixed inter digital transducer 140 includes a main body 143 coupled to the second electrode fixing portion 141 and extending in the fourth direction DR4, and a plurality of comb teeth 145. The comb teeth 145 of the second fixed inter digital transducer 140 are portions extending from the main body 143 in the first direction DR1 (and in the third direction DR3). A second movable inter digital transducer 240 includes a fourth coupling portion 440. The fourth coupling portion 440 is configured as a portion of the movable body MB and extends in the first direction DR1. The second movable inter digital transducer 240 has a plurality of comb teeth 245. The comb teeth 245 extend in the first direction DR1 (and in the third direction DR3) and face the comb teeth 145.

Meanwhile, as indicated by B11 in FIG. 6, the XY-direction acceleration sensor element 1 according to the present embodiment further includes a movable electrode fixing portion 311, a first movable electrode support portion 313, and a first spring 317. The movable electrode fixing portion 311 is fixed to the support substrate 10 and extends in the direction orthogonal to the support substrate 10.

The XY-direction acceleration sensor element 1 illustrated in FIG. 2 has a movable electrode fixing portion having a similar configuration to that of the movable electrode fixing portion 311, in addition to the movable electrode fixing portion 311. The movable electrode fixing portions may be collectively referred to as movable electrode fixing portions 301. Therefore, B11 illustrated in FIG. 6 can indicate, as appropriate, that the XY-direction acceleration sensor element 1 according to the present embodiment further includes the movable electrode fixing portions 301, the first movable electrode support portion 313, and the first spring 317. In addition, as will be described later, in the example illustrated in FIG. 2, the XY direction acceleration sensor element 1 includes four movable electrode fixing portions 301, but the number of movable electrode fixing portions 301 is not limited to four, and various modifications can be made.

The first spring 317 has a thin line shape in the plan view of the support substrate 10, and one end of the first spring 317 is coupled to the first movable electrode support portion 313. In addition, a portion to which the other end of the first spring 317 is coupled is not particularly limited as long as the first coupling portion 410 and the second coupling portion 420 can support the other end of the first spring 317, but the other end of the first spring 317 may be coupled to, for example, a corner portion of the movable body MB denoted by B111 in FIG. 6. It can be considered that the corner portion denoted by B111 is a portion where the first coupling portion 410 and the second coupling portion 420 intersect. In addition, due to the shape in which the thin line is folded in a bellows shape, the first spring 317 has a property as a folded spring and can be distorted and deformed in the XY plane.

The first movable electrode support portion 313 extends from the movable electrode fixing portion 301 (the movable electrode fixing portion 311) in a first intersecting direction DR11 and is coupled to the one end of the first spring 317. As illustrated in FIG. 6, the first intersecting direction DR11 intersects the first direction DR1 and the second direction DR2. In other words, the first intersecting direction DR11 is neither a direction parallel to the X axis (the first direction DR1 and the third direction DR3) nor a direction parallel to the Y axis (the second direction DR2 and the fourth direction DR4). In other words, the first intersecting direction DR11 is inclined with respect to the X axis and is inclined with respect to the Y axis.

In this manner, the movable electrode fixing portion 301 (movable electrode fixing portion 311), the first movable electrode support portion 313, the first spring 317, the corner portion of the movable body MB denoted by B111, the first coupling portion 410, and the first movable inter digital transducer 210 are coupled in this order. Similarly, the movable electrode fixing portion 301 (movable electrode fixing portion 311), the first movable electrode support portion 313, the first spring 317, the corner portion of the movable body MB denoted by B111, the second coupling portion 420, and the second movable inter digital transducer 220 are coupled in this order. Since the first coupling portion 410 and the second coupling portion 420 are coupled to the first movable inter digital transducer 210 and the second movable inter digital transducer 220, respectively, it can be said that the first movable inter digital transducer 210 and the second movable inter digital transducer 220 are supported by the support substrate 10.

In order to facilitate understanding, the first spring 317 is highlighted in FIG. 6, but the first spring 317 may be configured to be smaller. Specifically, for example, a length L313 of the first movable electrode support portion 313 may be longer than a length of the first spring 317. The length of the first spring 317 is based on the longest one of portions where a region occupied by the first spring 317 in the XY plane and a straight line parallel to the first intersecting direction DR11 intersect with each other. In this way, the first spring 317 can be located further outward. Therefore, the length L313 of the first movable electrode support portion 313 can be maximized. Accordingly, since it is possible to reduce the inertia moment based on the first movable electrode support portion 313, it is possible to suppress the operation of the movable body MB in the in-plane rotation mode (operation mode indicated by M20 in FIG. 2).

For example, the first movable electrode support portion 313, the main body 113, and the main body 123 may have a constant relationship between the length L313 of the first movable electrode support portion 313, a length L113 of the main body 113, and a length L123 of the main body 123. Specifically, for example, the main body 113, the main body 123, and the first movable electrode support portion 313 may have a relationship of "the length L313 > the length L113 and the length L313 > the length L123". In this case, it is possible to construct the XY-direction acceleration sensor element 1 in which the reference for the length of the first movable electrode support portion 313 necessary for suppressing the operation in the in-plane rotation mode is clearly defined. Thus, when the first spring 317 is deformed, the operation in the in-plane rotation mode can be suppressed.

As illustrated in FIG. 6, by making the first intersecting direction DR11 match a direction extending from the movable electrode fixing portion 301 (movable electrode fixing portion 311) toward the corner portion denoted by B111, it is possible to construct the configuration in which the first spring 317 is located further outward. Therefore, the length L313 of the first movable electrode support portion 313 can be maximized. Accordingly, since the inertia moment based on the first movable electrode support portion 313 can be reduced, it is possible to suppress the operation of the movable body MB in the in-plane rotation mode (the operation mode denoted by M20 in FIG. 2).

In the above-described configuration, the first fixed inter digital transducer 110 is arranged opposite to the first movable inter digital transducer 210, and the second fixed inter digital transducer 120 is arranged opposite to the second movable inter digital transducer 220, whereby electrostatic capacitance is formed. Specifically, in the first fixed inter digital transducer 110, the first movable inter digital transducer 210, the second fixed inter digital transducer 120, and the second movable inter digital transducer 220, specific surfaces of the facing comb teeth function as electrodes. For example, it is assumed that electrodes are formed on surfaces of the comb teeth 115 of the first fixed inter digital transducer 110 in the third direction DR3 and that electrodes are formed on surfaces of the comb teeth 215 of the first movable inter digital transducer 210 in the first direction DR1. In this case, electrodes are formed on surfaces of the comb teeth 135 of the first fixed inter digital transducer 130 in the first direction DR1, and electrodes are formed on surfaces of the comb teeth 235 of the first movable inter digital transducers 230 in the third direction DR3. In this case, when the distances between the electrodes of the comb teeth 115 and the electrodes of the comb teeth 215 increase in accordance with the acceleration in the first direction DR1, the distances between the electrodes of the comb teeth 135 and the electrodes of the comb teeth 235 decrease, and electrostatic capacitance changes.

It is also assumed that electrodes are formed on surfaces of the comb teeth 125 of the second fixed inter digital transducer 120 in the fourth direction DR4 and that electrodes are formed on surfaces of the comb teeth 225 of the second movable inter digital transducer 220 in the second direction DR2. In this case, electrodes are formed on surfaces of the comb teeth 145 of the second fixed inter digital transducer 140 in the second direction DR2, and electrodes are formed on surfaces of the comb teeth 245 of the second movable inter digital transducer 240 in the fourth direction DR4. In this case, when the distances between the electrodes of the comb teeth 125 and the electrodes of the comb teeth 225 increase in accordance with the acceleration in the second direction DR2, the distances between the electrodes of the comb teeth 145 and the electrodes of the comb teeth 245 decrease, and electrostatic capacitance changes. The XY-direction acceleration sensor element 1 detects changes in the acceleration in the first direction DR1 and the second direction DR2 based on the changes in the electrostatic capacitance as described above.

The Z-direction acceleration sensor element 101 detects acceleration in the Z direction orthogonal to the first direction DR1 and the second direction DR2. The Z-direction acceleration sensor element 101 only needs to be capable of detecting acceleration in the Z-direction, and various known configurations can be adopted.

### Detection Circuit

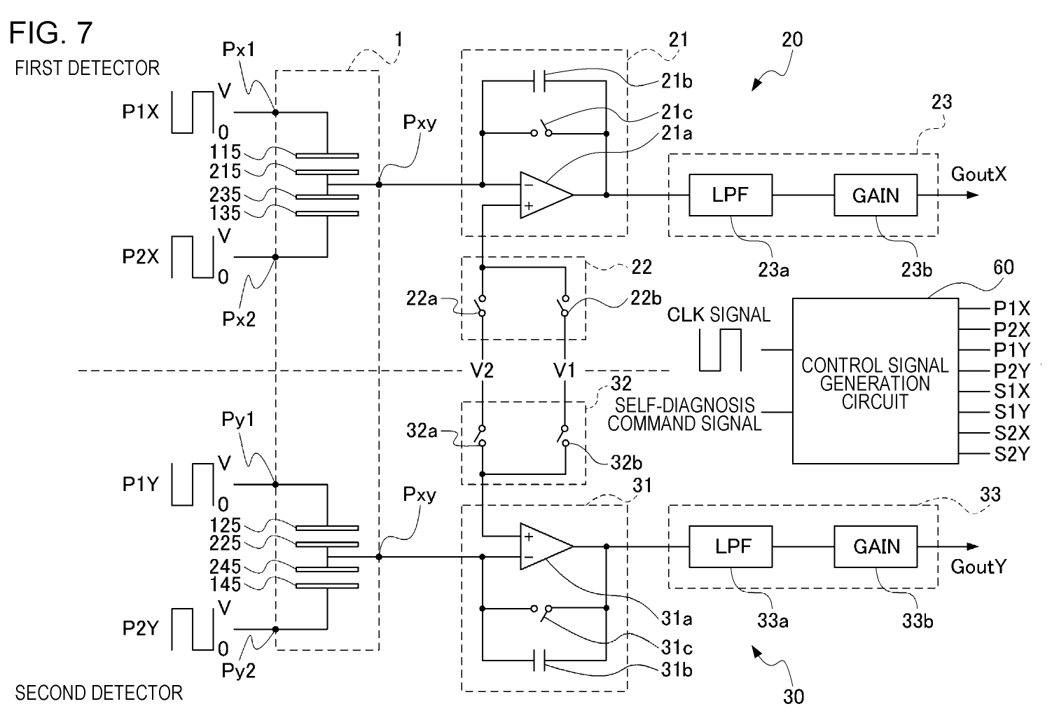

Next, a circuit for detecting changes in the acceleration in the first direction DR1 and the second direction DR2 using the above-described configuration will be described. In the Z-direction acceleration sensor element 101, the acceleration in the Z-direction can be detected using a circuit similar to a detection circuit that detects the acceleration using the XY-direction acceleration sensor element 1. The circuit for detecting changes in acceleration in the first direction DR1 and the second direction DR2 in the XY-direction acceleration sensor element 1 will be described. The XY direction acceleration sensor element 1 is used by being coupled to a control IC (not illustrated). The control IC includes a circuit for detecting acceleration based on a signal output from the XY-direction acceleration sensor element 1. FIG. 7 is a diagram for explaining the circuit. FIG. 7 illustrates the XY-direction acceleration sensor element 1 together with elements and wiring constituting the circuit.

However, details of the structure of the XY-direction acceleration sensor element 1 are omitted in FIG. 7, and FIG. 7 schematically illustrates the comb teeth 215, 235, 225, and 245 serving as movable electrodes and the comb teeth 115, 135, 125, and 145 serving as fixed electrodes included in the XY-direction acceleration sensor element 1.

The comb teeth 215 and 235 and the comb teeth 115 and 135 constitute a parallel-plate capacitor oriented in a direction orthogonal to the first direction DR1. The comb teeth 215 and 235 are electrodes that move in the first direction DR1 in accordance with acceleration in the X direction that is the first direction DR1. The positions of the comb teeth 115 and 135 are not displaced. When the comb teeth 215 and 235 are displaced in the first direction DR1 in accordance with the acceleration in the X direction that is the first direction DR1, the electrostatic capacitance formed by the comb teeth 215 and the comb teeth 115 and the electrostatic capacitance formed by the comb teeth 235 and the comb teeth 135 change.

The comb teeth 225 and 245 and the comb teeth 125 and 145 constitute a parallel-plate capacitor oriented in a direction orthogonal to the second direction DR2. The comb teeth 225 and 245 are electrodes that move in the second direction DR2 in accordance with acceleration in the Y direction that is the second direction DR2. The positions of the comb teeth 125 and 145 are not displaced. When the comb teeth 225 and 245 are displaced in the second direction DR2 in accordance with the acceleration in the Y direction that is the second direction DR2, the electrostatic capacitance formed by the comb teeth 225 and the comb teeth 125 and the electrostatic capacitance formed by the comb teeth 245 and the comb teeth 145 change.

As illustrated in FIG. 1, the XY-direction acceleration sensor element 1 includes a plurality of pads, and FIG. 7 illustrates a coupling relationship between the pads Pxy, Px1, Px2, Py1, and Py2 and circuit components and a coupling relationship between the comb teeth 215, 235, 225, and 245 and the comb teeth 115, 135, 125, and 145.

A component for detecting acceleration in the X direction that is the first direction DR1 is referred to as a first detector, and a component for detecting acceleration in the Y direction that is the second direction DR2 is referred to as a second detector. The first detector includes a detection circuit 20 that detects acceleration based on a change in differential capacitance caused by the comb teeth 215 and 235 and the comb teeth 115 and 135. The second detection unit includes a detection circuit 30 that detects acceleration based on a change in differential capacitance caused by the comb teeth 225 and 245 and the comb teeth 125 and 145.

The detection circuit 20 includes a C-V conversion circuit 21, a switch circuit 22, a signal processing circuit 23, and a control signal generation circuit 60. The detection circuit 30 includes a C-V conversion circuit 31, a switch circuit 32, a signal processing circuit 33, and the control signal generation circuit 60.

The C-V conversion circuits 21 and 31 convert a change in differential capacitance between the electrostatic capacitance formed by the comb teeth 215 to 245 and the comb teeth 115 to 145 into a voltage. Specifically, the C-V conversion circuits 21 and 31 include operational amplifiers 21a and 31a, capacitors 21b and 31b, and switches 21c and 31c, respectively.

An inverting input terminal of the operational amplifier 21a is electrically coupled to the comb teeth 215 and 235, and an inverting input terminal of the operational amplifier 31a is electrically coupled to the comb teeth 225 and 245. The capacitor 21b and the switch 21c are coupled in parallel between the inverting input terminal of the operational amplifier 21a and an output terminal of the C-V conversion circuit 21. The capacitor 31b and the switch 31c are coupled in parallel between the inverting input terminal of the operational amplifier 31a and an output terminal of the C-V conversion circuit 31. The switch 21c is driven by a signal S1X from the control signal generation circuit 60, and the switch 31c is driven by a signal S1Y from the control signal generation circuit 60. Either a voltage V1 (i.e., a midpoint voltage, 2.5 V in the present embodiment) that is half a voltage applied to the comb teeth 115 to 145 or a voltage V2 (4 V in the present embodiment) that is different from the midpoint voltage is input to non-inverting input terminals of the operational amplifiers 21a and 31a via the switch circuits 22 and 32.

The switch circuits 22 and 32 input voltages from respective voltage sources (not illustrated) to the non-inverting input terminals of the operational amplifiers 21a and 31a in the C-V conversion circuits 21 and 31. Specifically, the switch circuit 22 includes switches 22a and 22b, and the switch circuit 32 includes switches 32a and 32b. Among these switches, the switches 22a and 22b are driven based on a signal S2X from the control signal generation circuit 60, and the switches 32a and 32b are driven based on a signal S2Y from the control signal generation circuit 60. When one of the switches 22a and 22b is closed, the other of the switches 22a and 22b is opened. When one of the switches 32a and 32b is closed, the other of the switches 32a and 32b is opened.

The signal processing circuits 23 and 33 include low pass filter (LPF) circuits 23a and 33a and GAIN circuits 23b and 33b, respectively. The LPF circuits 23a and 33a remove high-frequency components from the outputs of the C-V conversion circuits 21 and 31, respectively, and extract only components in a predetermined band from the outputs of the C-V conversion circuits 21 and 31, respectively. The GAIN circuits 23b and 33b amplify the outputs that have passed through the LPF circuits 23a and 33a, and output the amplified outputs as accelerometer signals GoutX and GoutY, respectively.

The control signal generation circuit 60 outputs signals (carrier waves) P1X, P2X, P1Y, and P2Y indicating the timing of applying a voltage to the comb teeth 115 to 145, the signals S2X and S2Y indicating the switching timing of the switches of the switch circuits 22 and 32, and the signals S1X and S1Y indicating the switching timing of the switches 21c and 31c.

The various signals generated by the control signal generation circuit 60 change between the time of normal acceleration detection (when self-diagnosis is not performed) and the time of self-diagnosis. That is, the control signal generation circuit 60 outputs the various signals based on a clock signal CLK. The control signal generation circuit 60 outputs a signal for acceleration detection when a self-diagnosis command signal is at a low level, and outputs a signal for self-diagnosis when the self-diagnosis command signal is at a high level.

The self-diagnosis is a process of inputting the signal for self-diagnosis to the XY-direction acceleration sensor element 1 and determining that the XY-direction acceleration sensor element 1 is normal when an obtained output is within a predetermined range of a value expected to be output and that the XY-direction acceleration sensor element 1 is abnormal when the obtained output is out of the range. That is, if the obtained output is out of the range of the value expected to be output, it can be considered that abnormality such as breakage of a comb tooth included in the XY direction acceleration sensor element 1 occurs.

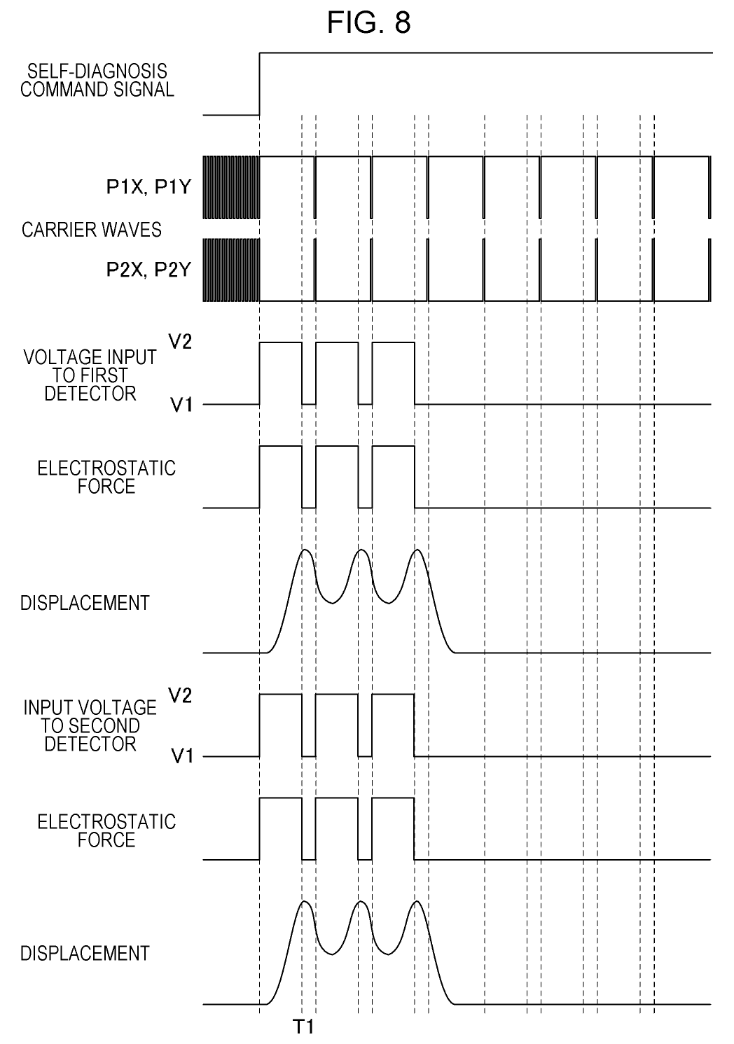

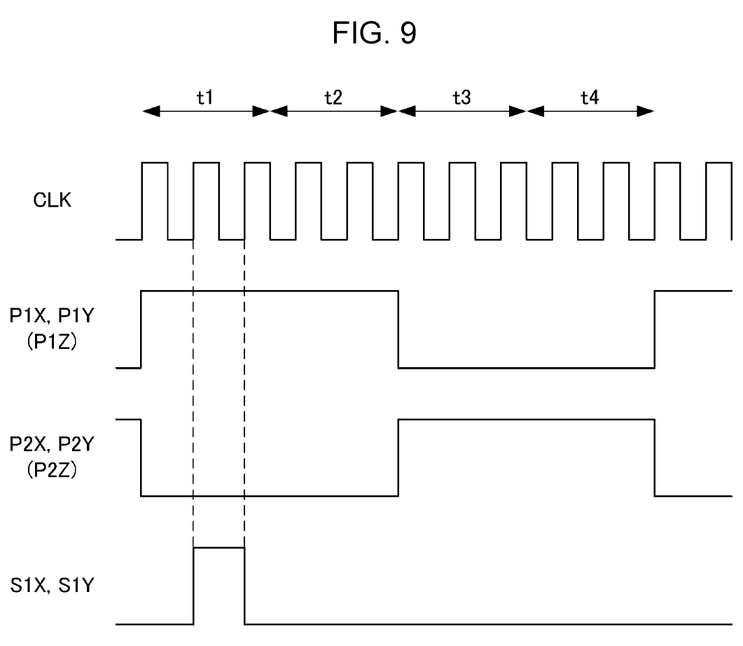

The operation of the acceleration sensor element configured as described above will be described with reference to signal waveform diagrams illustrated in FIGS. 8 and 9. FIG. 8 illustrates signal waveforms at the time of switching from the normal acceleration detection to the self-diagnosis, and FIG. 9 is an enlarged view of signal waveforms at the time of the acceleration detection.

First, as illustrated in FIG. 8, the self-diagnosis command signal is set to the low level at the time of the normal acceleration detection, and the acceleration detection is performed. The operation in this case will be described with reference to FIG. 9. Although not illustrated in FIG. 9, at the time of the normal acceleration detection, based on the signals S2X and S2Y, the switches 22a and 32a are opened, the switches 22b and 32b are closed, the midpoint voltage V1 (2.5 V in the present embodiment) is applied to the non-inverting input terminals of the operational amplifiers 21a and 31a, and the comb teeth 215 to 245 are set to the midpoint voltage V1.

The signals P1X, P2X, P1Y, and P2Y output from the control signal generation circuit 60 have an amplitude V (5 V in the present embodiment), the voltage level of the signal P1X is inverted from the voltage level of the signal P2X, and the voltage level of the signal P1Y is inverted from the voltage level of the signal P2Y. Each of the signals P1X, P2X, P1Y, and P2Y is a rectangular wave signal that has a constant amplitude and in which the high level and the low level change in four periods t1 to t4. Note that the voltage V is not limited to 5 V. For example, the voltage V may be 3 V, and the midpoint voltage V1 may be 1.5 V. Of course, in this case, the voltage V2 also changes between 3 V and 1.5 V.

First, in the first period t1, the electrical potentials of the comb teeth 115 and 125 are set to V and the electrical potentials of the comb teeth 135 and 145 are set to 0 based on the signals P1X and P2X and the signals P1Y and P2Y, and the switches 21c and 31c are closed by the signals S1X and S1Y from the control signal generation circuit 60. Therefore, the comb teeth 215 to 245 are biased to an electrical potential of V/2 by the operation of the operational amplifiers 21a and 31a, and electrical charge accumulated between electrodes of the capacitors 21b and 31b serving as feedback capacitance is discharged.

In this case, if capacitance C1 between the comb teeth 215 and 225 and the comb teeth 115 and 125 and capacitance C2 between the comb teeth 235 and 245 and the comb teeth 135 and 145 have a relationship of C1 > C2, the comb teeth 215 to 245 have a large amount of negative electrical charge due to this relationship and the relationship between electrical potentials applied to the comb teeth 115 to 145.

Next, in the second period t2, the electrical potentials of the comb teeth 115 and 125 are kept at V and the electrical potentials of the comb teeth 135 and 145 are kept at 0 based on the signals P1X and P2X and the signals P1Y and P2Y, and the switches 21c and 31c are opened by the signals S1X and S1Y from the control signal generation circuit 60. Therefore, electrical charge corresponding to the states of the comb teeth 215 to 245 is stored in the capacitors 21b and 31b. In this case, when voltage values corresponding to the electrical charge accumulated in the capacitors 21b and 31b are output from the C-V conversion circuits 21 and 31, the outputs GoutX and GoutY in this case are sampled via the LPF circuit 23a and the GAIN circuit 23b.

Subsequently, in the third period t3, the electrical potentials of the comb teeth 115 and 125 are switched to 0 and the electrical potentials of the comb teeth 135 and 145 are switched to V based on the signals P1X and P2X and the signals P1Y and P2Y, and the switches 21c and 31c are kept opened by the signals S1X and S1Y from the control signal generation circuit 60.

In this case, the states of the electrical charge of the comb teeth 215 to 245 in the third period t3 are opposite to those in the second period t2 due to the inversion of the signals P1X, P2X, P1Y, and P2Y. That is, as described above, when the relationship of C1 > C2 is satisfied, the comb teeth 215 to 245 have a large amount of positive electrical charge due to the inversion of the electrical potentials applied to the comb teeth 115 to 145.

However, in this case, a closed circuit is formed between the comb teeth 215 to 245 and the capacitors 21b and 31b, and electrical charge in an amount in the first period t1 is stored. Therefore, electrical charge overflowing from the balance of the amounts of electrical charge of the comb teeth 215 to 245 is moved to and stored in the capacitors 21b and 31b. Then, based on the relationship of Q = CV, a voltage value that is proportional to the amount of electrical charge that has moved, and that is inversely proportional to the capacitance C of the capacitors 21b and 31b is output from the C-V conversion circuits 21 and 31.

Further, in the fourth period t4, the electrical potentials of the comb teeth 115 and 125 are kept at 0 and the electrical potentials of the comb teeth 135 and 145 are kept at V based on the signals P1X, P2X and P1Y, P2Y, and when the outputs of the C-V conversion circuits 21 and 31 are sufficiently stabilized, the values in this case are output to GoutX and GoutY via the LPF circuits 23a and 33a and the GAIN circuits 23b and 33b.

Finally, differences between the outputs GoutX and GoutY sampled in the second period t2 and the outputs GoutX and GoutY sampled in the fourth period t4 are calculated. Then, based on the calculated differences, acceleration detection corresponding to the displacement of the comb teeth 215 to 245 is performed.

Next, an operation at the time of self-diagnosis will be described based on FIG. 8. At the time of self-diagnosis, the self-diagnosis command signal at the high level is input to the control signal generation circuit 60, and various signals for self-diagnosis are output from the control signal generation circuit 60. In the present embodiment, self-diagnosis in the first detector and self-diagnosis in the second detector are simultaneously performed.

At the time of self-diagnosis, a difference in electrical potential between the comb teeth 115 and 125 and the comb teeth 135 and 145 occurs based on the signals P1X, P2X and the signals P1Y, P2Y. For the first detector, the switch 22a of the switch circuit 22 is closed and the switch 22b of the switch circuit 22 is opened based on the signal S2X. Therefore, the voltage V2 (4 V in the present embodiment) different from the midpoint voltage V1 of the comb teeth 115 and 135 is applied to the non-inverting input terminal of the operational amplifier 21a for self-diagnosis.

As a result, the difference (4 V) in electrical potential between the comb teeth 235 and the comb teeth 135 becomes larger than the difference (1 V) in electrical potential between the comb teeth 215 and the comb teeth 115, and electrostatic force increases. Therefore, the comb teeth 215 and 235 are forcibly moved from the center point by the electrostatic force. Subsequently, at time T1, the switch circuit 22 performs switching based on the signal S2X, and the midpoint voltage V1 of the comb teeth 115 and 135 is applied to the non-inverting input terminal of the operational amplifier 21a as in the case of the normal acceleration detection.

For the second detector, the switch 32a of the switch circuit 32 is closed and the switch 32b of the switch circuit 32 is opened based on the signal S2Y. Therefore, the voltage V2 (4 V in the present embodiment) different from the midpoint voltage V1 of the comb teeth 125 and 145 is applied to the non-inverting input terminal of the operational amplifier 31a for self-diagnosis.

As a result, the difference (4 V) in electrical potential between the comb teeth 245 and the comb teeth 145 becomes larger than the difference (1 V) in electrical potential between the comb teeth 225 and the comb teeth 125, and electrostatic force increases. Therefore, the comb teeth 225 and 245 are forcibly moved from the center point by the electrostatic force. Subsequently, at time T1, the switch circuit 32 performs switching based on the signal S2Y, and the midpoint voltage V1 of the comb teeth 125 and 145 is applied to the non-inverting input terminal of the operational amplifier 31a as in the case of the normal acceleration detection.

In the present embodiment, a signal for displacing the first fixed inter digital transducers 110 and 130 and the second movable inter digital transducers 220 and 240 is identical for both the first detector and the second detector. That is, the frequency of the signal is identical for both the first detector and the second detector, and a change in the signal over time is identical for both the first detector and the second detector. As a result, as illustrated in FIG. 8, a voltage input to the first detector and a voltage input to the second detector change at the same timing. Therefore, in the present embodiment, the first fixed inter digital transducers 110 and 130 and the second movable inter digital transducers 220 and 240 can be changed in synchronization.

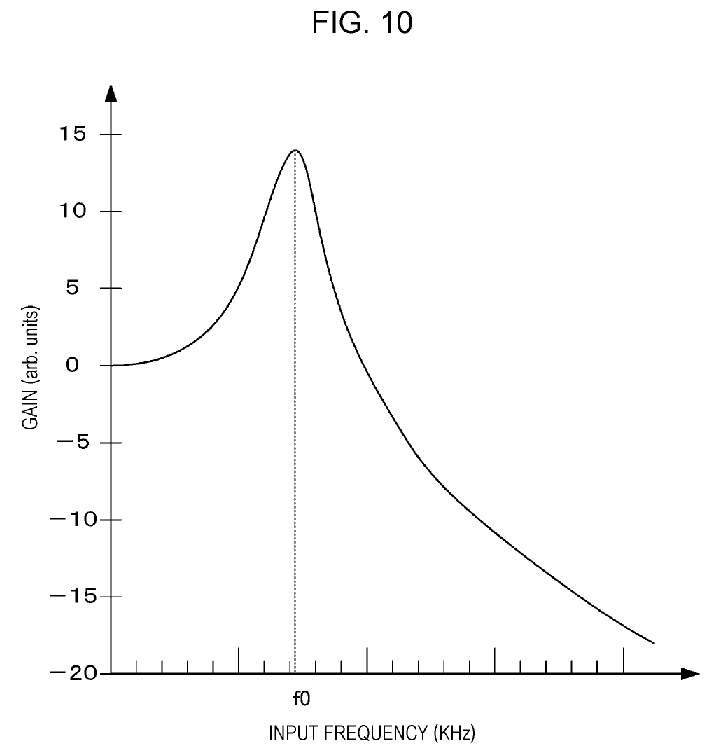

By the above-described processing, the comb teeth 215, 235, 225, and 245 can be displaced by the electrostatic force. In the present embodiment, the period of the drive signal S2X of the switch circuit 22 is set and the time for generating the electrostatic force is controlled such that the amounts of the displacement can be sufficiently detected. For example, the resonance frequency characteristics of the vibrations of the comb teeth 215, 235, 225, and 245 with respect to input frequencies of voltages applied to the comb teeth 215, 235, 225, and 245 are expressed as illustrated in FIG. 10. In the present embodiment, the frequency of the input signal, that is, the frequency of the input voltage to the first detector illustrated in FIG. 8 is set to be a resonance frequency f0. As a result, vibrations in the comb teeth 215 and 235 are generated at a frequency at which the comb teeth 215, 235, 225, and 245 resonate, that is, a frequency at which the amounts of the displacement of the comb teeth 215, 235, 225, and 245 are maximized.

After that, the same operation as the above-described normal acceleration detection is performed on the first detector and the second detector, and outputs GoutX and GoutY corresponding to the amounts of displacement of the comb teeth 215, 235, 225, and 245 are obtained. In this case, since the amounts of the displacement of the comb teeth 215, 235, 225, and 245 due to the electrostatic force are uniquely determined by the voltage applied to the non-inverting input terminal of the operational amplifier 21a, the outputs corresponding to the amounts of the displacement of the comb teeth 215, 235, 225, and 245 are also uniquely determined. By comparing the obtained outputs with uniquely determined self-diagnosis amounts (outputs), self-diagnosis is performed on the first detector and the second detector.

In the present embodiment, the comb teeth 215, 235, 225, and 245 are made of silicon. Therefore, the Q value is low. For example, the Q value of a quartz crystal resonator frequently used in a gyro sensor or the like is on the order of 30000 or the like, but the Q value of the comb teeth 215, 235, 225, and 245 configured as comb teeth of silicon MEMS is about 20. Therefore, a vibration forcibly induced at the time of self-diagnosis of each of the first detector and the second detector converges in a very short time.

In the present embodiment, the first movable inter digital transducers 210 and 230 and the second movable inter digital transducers 220 and 240 have the same shape. The masses and materials of the electrodes are also the same. Therefore, the resonance frequencies f0 of the first movable inter digital transducers 210 and 230 and the second movable inter digital transducers 220 and 240 are the same. As described above, at the time of self-diagnosis, a signal for displacing the first movable inter digital transducers 210 and 230 and the second movable inter digital transducers 220 and 240 and having a frequency equal to the resonance frequency is applied between the first movable inter digital transducers 210 and 230 and the first fixed inter digital transducers 110 and 130 and between the second movable inter digital transducers 220 and 240 and the second fixed inter digital transducer 120 and 140.

Specifically, the resonance frequency characteristics of the vibrations of the first movable inter digital transducers 210 and 230 and the second movable inter digital transducers 220 and 240 with respect to the input frequency of the voltage applied to the first fixed inter digital transducers 110 and 130 and the second fixed inter digital transducers 120 and 140 are expressed as illustrated in FIG. 10. In the present embodiment, the frequency of the input signal (V1 and V2) for displacing the first movable inter digital transducers 210 and 230 and the second movable inter digital transducers 220 and 240, that is, the frequency of the input voltage to the first detector and the second detector illustrated in FIG. 8 is set to be the resonance frequency f0. As a result, vibrations in the first movable inter digital transducers 210 and 230 and the second movable inter digital transducers 220 and 240 are generated at a frequency at which the first movable inter digital transducers 210 and 230 and the second movable inter digital transducers 220 and 240 resonate, that is, a frequency at which the amounts of the displacement of the comb teeth 215, 235, 225, and 245 are maximized.

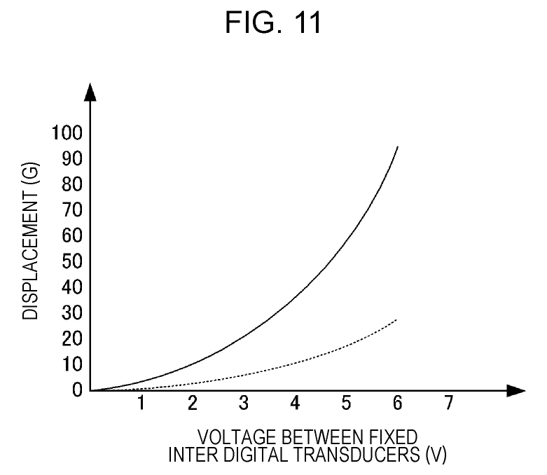

According to the above-described configuration, the amounts of the displacement of the first movable inter digital transducers 210 and 230 and the second movable inter digital transducers 220 and 240 are large, and it is easy to detect a change in the amounts of the displacement due to a slight breakage of the comb teeth. FIG. 11 is a diagram illustrating displacement with respect to a voltage between the first fixed inter digital transducers 110 and 130 and the second fixed inter digital transducers 120 and 140. In FIG. 11, a solid line indicates a case where the frequency of the voltage is the resonance frequency, and a broken line indicates a case where the frequency of the voltage is not the resonance frequency (1 Hz in an example illustrated in FIG. 11). The displacement is a value of gravitational acceleration detected based on the displacement of the first movable inter digital transducers 210 and 230 and the second movable inter digital transducers 220 and 240.

As illustrated in FIG. 11, for example, if the voltage as the input signal is 3 V, and the frequency of the input signal is 1 Hz, only displacement corresponding to a displacement of 5G occurs. On the other hand, if the frequency of the input signal is the resonance frequency, displacement corresponding to a displacement of 20G occurs. Therefore, there is a high possibility that even a slight breakage of the comb teeth causes a difference between the amounts of displacement and that an abnormality can be accurately detected.

### Other Embodiments

The above embodiment is an example of carrying out the present disclosure. Therefore, the configuration of each portion can be replaced with any configuration having the same function as that of the portion. Additionally, any other components may be added to the present disclosure.

A first electrode fixing portion, a second electrode fixing portion, and a movable electrode fixing portion are portions extending in the direction orthogonal to the support substrate, and may be portions that support other portions. That is, a support substrate supports another structure, and each portion of a physical quantity sensor element is directly or indirectly supported by the support substrate. The first electrode fixing portion, the second electrode fixing portion, and the movable electrode fixing portion are directly supported by the support substrate.

An electrode that is regarded to be fixed without moving relative to the support substrate is a fixed electrode, and an electrode that is moved relative to the support substrate or a portion fixed to the support substrate is a movable electrode. The first electrode fixing portion and the second electrode fixing portion support a first fixed inter digital transducer and a second fixed inter digital transducer, respectively. The first electrode fixing portion and the second electrode fixing portion may be coupled to other portions and may support other portions. The shapes and the sizes of the first electrode fixing portion and the second electrode fixing portion, and the positions of the first electrode fixing portion and the second electrode fixing portion on the support substrate may be variously changed.

A first movable inter digital transducer and a second movable inter digital transducer may be coupled to a movable electrode fixing portion, and may be arranged opposite to the first fixed inter digital transducer and the second fixed inter digital transducer, respectively. That is, the number of movable electrode fixing portions may be one or more. The first movable inter digital transducer and the second movable inter digital transducer may be directly or indirectly coupled to one or more movable electrode fixing portions. In any case, the first movable inter digital transducer and the second movable inter digital transducer are arranged opposite to the different fixed inter digital transducers, respectively, and may be movable in both the first direction and the second direction as a whole.

The first movable inter digital transducer and the first fixed inter digital transducer may be arranged opposite to each other. The first fixed inter digital transducer may be fixed relative to the support substrate, and the first movable inter digital transducer may be displaceable relative to the first fixed inter digital transducer. That is, a distance of a capacitor formed by the first movable inter digital transducer and the first fixed inter digital transducer, that is, the distance between the first movable inter digital transducer and the first fixed inter digital transducer that form the capacitor may be changed by the displacement of the first movable inter digital transducer.

The second movable inter digital transducer and the second fixed inter digital transducer may be arranged opposite to each other. The second fixed inter digital transducer may be fixed relative to the support substrate, and the second movable inter digital transducer may be displaceable relative to the second fixed inter digital transducer. That is, a distance of a capacitor formed by the second movable inter digital transducer and the second fixed inter digital transducer, that is, the distance between the second movable inter digital transducer and the second fixed inter digital transducer that form the capacitor may be changed by the displacement of the second movable inter digital transducer.

The first movable inter digital transducer and the second movable inter digital transducer have the same resonance frequency. The first movable inter digital transducer and the second movable inter digital transducer are different in orientation by 90°, but are the same in at least one of mass, size, structure, and material, and are configured to resonate at the same frequency.

At the time of self-diagnosis, a signal for displacing the first movable inter digital transducer and the second movable inter digital transducer is applied between the first movable inter digital transducer and the first fixed inter digital transducer and between the second movable inter digital transducer and the second fixed inter digital transducer. Since the frequency of the signal is equal to the resonance frequency, both the first movable inter digital transducer and the second movable inter digital transducer may resonate by the signal, and the amounts of displacement may be larger than those in a case where the first movable inter digital transducer and the second movable inter digital transducer do not resonate.

What is claimed is:

1. A physical quantity sensor element comprising:
a first electrode fixing portion, a second electrode fixing portion, and a movable electrode fixing portion that extend in a direction orthogonal to a support substrate;
a first fixed inter digital transducer coupled to the first electrode fixing portion and including a main body extending in a first direction parallel to the support substrate, and comb teeth extending in a second direction parallel to the support substrate and orthogonal to the first direction;
a second fixed inter digital transducer coupled to the second electrode fixing portion and including a main body extending in the second direction, and comb teeth extending in the first direction;
a first movable inter digital transducer coupled to the movable electrode fixing portion and arranged opposite to the first fixed inter digital transducer; and
a second movable inter digital transducer coupled to the movable electrode fixing portion and arranged opposite to the second fixed inter digital transducer, wherein
the first movable inter digital transducer and the second movable inter digital transducer have a same resonance frequency, and
at time of self-diagnosis, a signal for displacing the first movable inter digital transducer and the second movable inter digital transducer and having a frequency equal to the resonance frequency is applied between the first movable inter digital transducer and the first fixed inter digital transducer and between the second movable inter digital transducer and the second fixed inter digital transducer.

2. A physical quantity sensor device comprising:
the physical quantity sensor element according to claim 1;
a control signal generation circuit that periodically applies, between the first movable inter digital transducer and the first fixed inter digital transducer and between the second movable inter digital transducer and the second fixed inter digital transducer, a signal for detecting a change in capacitance at time of a normal operation that is not the self-diagnosis, and that periodically applies, between the first movable inter digital transducer and the first fixed inter digital transducer and between the second movable inter digital transducer and the second fixed inter digital transducer, a signal having the resonance frequency for performing the self-diagnosis instead of the signal for detecting the change in the capacitance at the time of the self-diagnosis;
a C-V conversion circuit that outputs a voltage corresponding to a change in capacitance between the first movable inter digital transducer and the first fixed inter digital transducer and a change in capacitance between the second movable inter digital transducer and the second fixed inter digital transducer; and
a signal processing circuit that performs signal processing on the voltage output by the C-V conversion circuit and outputs a signal corresponding to a change in a physical quantity.

3. The physical quantity sensor device according to claim 2, wherein
the signal for displacing the first movable inter digital transducer and the second movable inter digital transducer is applied between the first movable inter digital transducer and the first fixed inter digital transducer and between the second movable inter digital transducer and the second fixed inter digital transducer,
the frequency of the signal is equal to the resonance frequency and is identical for the first movable inter digital transducer and the second movable inter digital transducer, and
a change in the signal over time is identical for the first movable inter digital transducer and the second movable inter digital transducer.
